(19) United States
(12) Patent Application Publication
(10) Pub. No.: US 2007/0144652 A1
(43) Pub. Date: Jun. 28, 2007

(54) System for manufacturing an inlay panel using a laser

(76) Inventor: Blake Edward Ratcliffe, Ann Arbor, MI (US)

Correspondence Address: Rohm & Monsanto, PLC, 12 Rathbone Place, Grosse Pointe, MI, 48230, US

(21) Appl. No.: 11/580,143

(22) Filed: Oct. 11, 2006

Related U.S. Application Data
(63) Continuation of application No. 10/171,166, filed on Jun. 13, 2002, now abandoned.

(51) Int. Cl. H01B 13/26

(52) U.S. Cl. 156/53

(57) ABSTRACT

A method for manufacturing a laser-cut, inlayed panel uses a computerized laser-cutting technique that includes the steps of: providing an art master rendering that is desired to constitute a decorative design for the inlaid panel; scanning electronically the art master to form an art master data file; transferring the art master data file to a CAD software system to form an art master CAD file having machine code coordinates; coordinating a laser beam to cut-through a first background panel and create negative image voids on the inlaid panel; driving a CNC laser cutting machine in response to the machine code coordinates; second coordinating a laser beam to cut through a second panel for forming positive images that become inlay elements; bonding the first background panel and the second panel for forming a composite panel; placing the inlay element in appropriate voided spaces on the background panel and bonded to the substrate; finishing the composite panel; finishing the inlay elements. The finished composite panel with affixed inlay elements is incorporated into an overall furniture or decorative object. The process may be applied to articles where the surface is curved or arcuate.

### RELATIONSHIP TO OTHER APPLICATION

This application claims the benefit of U.S. Provisional Application No. 60/297,850 filed Jun. 13, 2001, and is a continuation of U.S. patent application Ser. No. 10/171,166 filed on Jun. 16, 2002.

### BACKGROUND OF THE INVENTION

1. Field of the Invention

This invention relates generally to systems for manufacturing panels, and more particularly, to a system for fabricating decorative panels having intricate decorative designs inlaid therein using a laser.

2. Description of the Related Art

Inlays have been incorporated into the construction of furniture and the decorative arts for centuries. Typical inlay applications vary widely and encompass many different materials and methods—from stone plaque with an embedded metal design, to table tops constructed with die-cut veneer of differing wood species assembled jig-saw puzzle style and bonded to a substrate. However, while inlays themselves vary widely, there are significant difficulties in the art and industry of creating inlay panels. One such difficulty is that the industry is labor intensive and requires a high degree of skill from the artisan. Consequently, the resulting product is correspondingly expensive. In addition, cutting both the positive and negative images required by an inlay is tedious.

The prior art has thrust at these and other known problems by developing a number of methods over the years to facilitate the art of inlay. In one known system, a router is used to excavate a wood panel and then the excavated void is filled with a malleable inlay material that will cure to a hardness greater than that of the background wood panel. This known system, however, falls short of efficiently controlling the design accuracy and work efficiency.

Mechanical routers linked to CNC systems have been used to increase efficiency and accuracy. However, router based systems are limited in the quality of the detail that can be cut. Moreover, the design tolerances, which are of particular importance in the corners of the design, are limited by the diameter of the router's cutting head. Generally, the cutting head must be of sufficiently diameter to withstand the cutting of many boards, and therefore delicate and detailed patterns are not achievable.

In a known system that employs lasers to create contrasting depressions in two wafers, one wafer being embossed with an image and the other being engraved with the same image, the surfaces of these two wafers are mated, and the joined piece is then sanded or planed to reveal the inlay design. In more refined laser systems, the ability to create intricate inlays by the use of a laser is enhanced, but the inlays must be sanded or planed flush to reveal their inlay designs. Thus, the inlay designs are limited to only single-plane surfaces. Also, a maximum of two materials may be introduced into the inlay design without requiting extraordinary work-arounds. Generally, the inlay can only be flush, as inlays in raised relief or recessed relief are not achievable.

A known arrangement that avoids some of the aforementioned disadvantages creates a raised relief designs by angle cutting with a saw elements that can then be inserted into a base piece to form a relief design that protrudes from one surface of the base. However, this method is based on a saw cut method and can only be used to create a raised relief inlay. Furthermore, none of the prior art arrangements and methods are suitable for mass scale, repeatable operation using CNC technology.

Almost all known inlay methods requite sanding or planing after the assembly of the inlay. A significant drawback to this is that color, which is required to make the inlay stand out, must be impregnated in the material being inlayed. If the color were simply sprayed on to the surface, it would be sanded or planed away. The only way to avoid this problem requires a time-consuming and expensive use of masking tape to isolate each inlay element from its neighboring elements and then subjecting the product to spot finishing. All too often, however, even with such precautions the colors will often bleed past the boundaries blocked by the masking tape and ruin the effect of the inlay.

In yet another known system, a pre-sanded surface panel is cut-through using a laser, and a channel is then CNC router cut in a second substrate panel. The laser-cut surface panel is then partially bonded to the substrate panel at the periphery. The bonded panels were then edge-banded sanded, stained and finished. After this, a sheet of laminate then is slid into the routered channel formed between the laser-cut surface panel and the substitute panel. When the laminate sheet is in place, a colorful design is then visible through the laser cut design in the surface panel. This known technique, however, suffers from significant disadvantages, including that the surface sheet cannot adequately be secured to the substrate. Thus, over time, humidity causes warpage, cracking, and detachment. In addition, this known technique only allows thin sheets of laminate to used as the material that is revealed through the laser cut design in the surface panel.

There is a need for a method of manufacturing colorful and intricate inlay panels that overcomes the disadvantages of the prior art.

It is, therefore, an object of this invention to provide a method of manufacturing inlay panels wherein recessed relief or raised relief can readily be achieved.

It is another object of this invention to provide a method of manufacturing inlay panels wherein materials having different thicknesses can be bonded flush.

It is also an object of this invention to provide a method of manufacturing inlay panels wherein novel and intricate designs can inexpensively be stored and re-run in a mass production setting.

It is a further object of this invention to provide a method of manufacturing inlay panels wherein panels can be created using a wider variety of materials than can be used with prior art methods.

It is additionally an object of this invention to provide an economical method of manufacturing inlay panels wherein the resulting inlay panels are reproducible on a mass scale and are durably constructed.

### SUMMARY OF THE INVENTION

The foregoing and other objects are achieved by this invention which provides a method of making an inlaid panel using a laser cutter. In accordance with a first method aspect of the invention, there are provided the steps of:
a. providing an art master rendering that is desired to constitute a decorative design for the inlaid panel;
b. scanning electronically the art master to form an art master data file;
c. transferring the art master data file to a CAD software system to form an art master CAD file having machine code coordinates;
d. coordinating a laser beam to cut-through a first background panel and create negative image voids on the inlaid panel;
e. driving a CNC laser cutting machine in response to the machine code coordinates;
f. second coordinating a laser beam to cut through a second panel for forming positive images that become inlay elements;
g. bonding the first background panel and the second panel for forming a composite panel;
h. placing the inlay element in appropriate voided spaces on the background panel and bonded to the substrate;
i. finishing the composite panel; and
j. finishing the inlay elements.

In one embodiment of the invention, the finished composite panel with affixed inlay elements is integrated into an overall furniture or decorative object. Additionally, the finished composite panel may itself be incorporated into a further finished composite panel, whereby a nested decorative effect is achieved.

Prior to performing said step of second coordinating there is further provided in a specific embodiment of the invention the step of readjusting the machine code coordinates. Such readjustment may include, for example: converting curves that previously were auto-formed as tiny linear approximations into mathematically described curves; straightening imperfect lines, if it improves the design; and offsetting the image if the image contains fine detail, whereby an allowance is made for the laser beam width.

The background panel is bonded, in certain embodiments to a substrate panel, and a backer panel may be affixed to the composite panel. Subsequently, an edger material is affixed, illustratively by a glue bond, to the composite panel. Other structural support and decorative elements can then be coupled to the composite panel.

In accordance with a further method aspect of the invention, there is provided a method of producing an inlay of one material in another material, the method comprising the steps of:

a. electronically scanning an art master;

b. first laser cutting a panel to create a voided image in the panel;

c. second laser cutting to create an inlay image; and

d. bonding the panel and the inlay image to a substrate to form an inlayed panel.

In one embodiment of the further method aspect of the invention, prior to performing said step of electronically scanning there is provided the further step of forming the art master as a graphic design. During said step of electronically scanning there is provided the further step of converting the graphic design into machine code, which may be a CAD format. Preferably, the machine code in CAD format is enabled to drive a laser-cutting machine, particularly a CNC work table therefor. In some embodiments, there is a need to clean the machine code in CAD format so that it can drive a laser-cutting machine.

The machine code in CAD format controls a laser beam to cut a negative, voided image in a background panel. The negative, background panel is then bonded to a substrate panel. The machine code in CAD format controls a laser beam to cut a positive image in an inlay panel. The background panel is made of wood, and there is provided the further step of staining the background panel without affecting the inlay element. In another embodiment, the background panel is sealed without affecting the inlay element.

This present invention most generally relates to a process for creating decorative inlays. More particularly, this invention relates a method of making inlaid panels using a laser cutting technique to create one or many voided images in a background panel into which one or many inlay elements of various material composition can be inserted. Materials that are usable for the background panel and for the inlay elements include, but are not limited to, solid wood, metal, plywood, MDF, laminate, solid surfacing (generally polyester or acrylic compounds such as Corian), plastic, etc. Such panels may be incorporated into all kinds of furniture including, but not limited to, signage, shelving, bed head-boards, space dividers, chair parts, library carrel panels, table surfaces, table bases, kitchen counter tops, doors, lighting fixtures, chests of drawers, clock faces, etc. The process for producing designs and patterns in such products results in inlays that may be flush with a frame panel, may form a raised relief, or that may form a recessed relief.

The computerized laser-cutting and manufacturing process of the present invention has an economical and time-saving aspect whereby an electronically scanned art master can be combined with the precise accuracy and mass production capability of a laser-cutting system to create a unique panel product. Additionally, this invention primarily concerns the creation of inlay panels that may be complete furniture objects in themselves (as in the case of a library shelf end panel) or might simply be panel elements incorporated within large furniture designs, as in the case of a door panel incorporated into a larger cabinet.

### BRIEF DESCRIPTION OF THE DRAWING

Comprehension of the invention is facilitated by reading the following detailed description, in conjunction with the annexed drawing, in which:

FIG. 1 is a simplified function block and schematic representation that illustrates a laser cutting process for an inlay in accordance with the principles of the invention;

FIG. 2 is a simplified function block and schematic representation that illustrates an assembly process for creating a finished product having an inlay in accordance with the principles of the invention;

FIG. 3 is a representation of an art master in the form of a free-hand sketch, showing the cutting pathways for the inlay material panel;

FIG. 4 is a representation of the art master of FIG. 3 showing the cutting pathways for the background panel;

FIG. 5 is a representation of the application if a glue on a substrate panel using a roller;

FIG. 6 is a representation of the installation of the background panel onto the substrate panel with glue applied thereon as shown in FIG. 5;

FIG. 7 is a representation of a background panel with a laser cut therein separated from inlay elements formed of a laminate in this specific illustrative embodiment of the invention;

FIG. 8 is a representation of a completed panel having a raised inlay installed thereon;

FIG. 9 is a cross-sectional representation of an embodiment of the invention having a raised relief characteristic;

FIG. 10 is a cross-sectional representation of an embodiment of the invention having a flush relief characteristic; and

FIG. 11 is a cross-sectional representation of an embodiment of the invention having a recessed relief characteristic.

### DETAILED DESCRIPTION

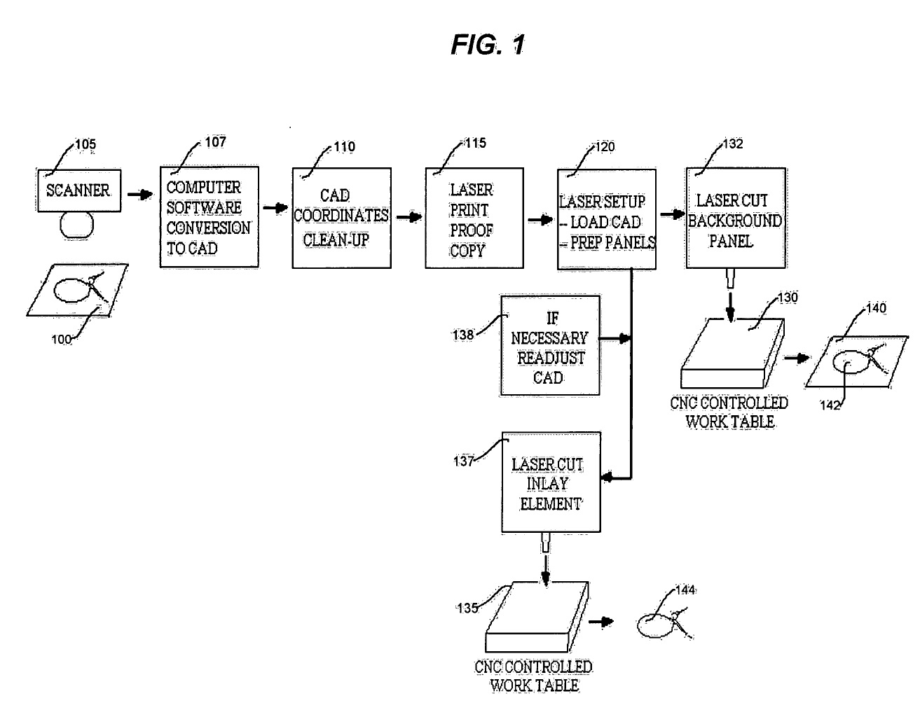

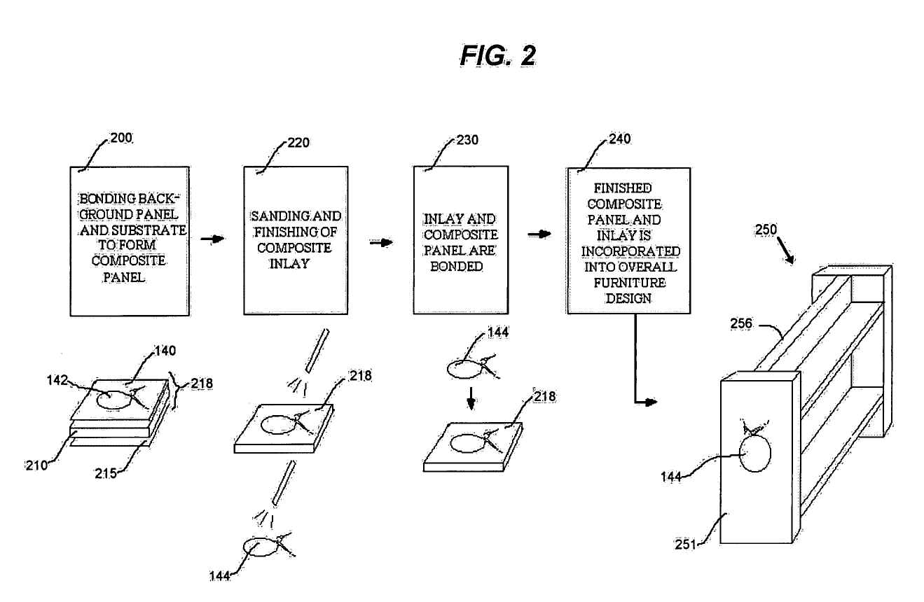

FIG. 1 is a simplified function block and schematic representation that illustrates a laser cutting process for an inlay in accordance with the principles of the invention. As shown in this figure, there is first provided an art master 100 that is provided by a designer (not shown). It is assumed that at this stage of commencement of manufacture the designer has already specified the greater context for the ultimate design of the panel within the furniture or decorative object (whether it be signage, shelf panel, door, etc.). As will be seen in connection with FIG. 2, the article to be manufactured by this illustrative process, is a shelf unit. In addition, this disclosure of a specific illustrative embodiment of the invention will focus on the cutting of a wood veneer, illustratively on a medium density fiberboard (“MDF”) core as the frame panel, and high pressure plastic laminate (“HPPL”) as the inlay element panel.

Art master 100 may be a hand or mechanically drawn rendering of a designed desired to be used artistically in the manufacture of the decorative object. A scanner 105 is used to convert the image on art master 100 into a data stream (not shown) in a conventional manner. In this specific illustrative embodiment of the invention, scanner 105 is a conventional scanner, such as a conventional Epson flat bed scanner. The file that results from the data stream is stored, in this embodiment, as an .eps, bit map, or other suitable graphics document in a personal computer (not shown) to which scanner 105 is connected. At step 107, the data in the .eps file corresponding to the image on art master 100 is converted into a suitable computer-aided design (“CAD”) format, illustratively by tracing. In a practical embodiment of the invention, the data file compatible with AutoCAD Lite v. 12. is created.

In one embodiment of the invention, the eps file from scanner 105 is printed to form an Adobe file, illustratively a portable document format (.PDF) which is used as a background element and then drawn over using AutoCAD Lite v. 12. as lines thereon.

In yet a further embodiment, art master 100 is initially generated in a machine coded graphic design program such as Adobe FreeHand or Claris QuickDraw. This would create a computer file that would obviate the need for scanning the art master, as described hereinabove. Irrespective of whether the art master is initially drawn in a machine coded graphic design program or scanned as described above, care is taken ensure that the art work does not have thin peninsulas or voided shapes that would create difficulty during subsequent cutting, as will be described below, or that would cause the design not to be recognizable when the inlay is installed.

The CAD software system is of the type that provides machine code coordinates capable of driving a CNC laser cutting machine. At step 110, the CAD image is cleaned-up. That is, the lines of the drawing are tweaked, jagged edges that sometimes result from the scanning process are smoothed, etc. A hard copy of the resulting CAD art master is printed onto paper at step 115. The printout is then proofed by the designer (not shown) to ensure conformity with the original design intentions.

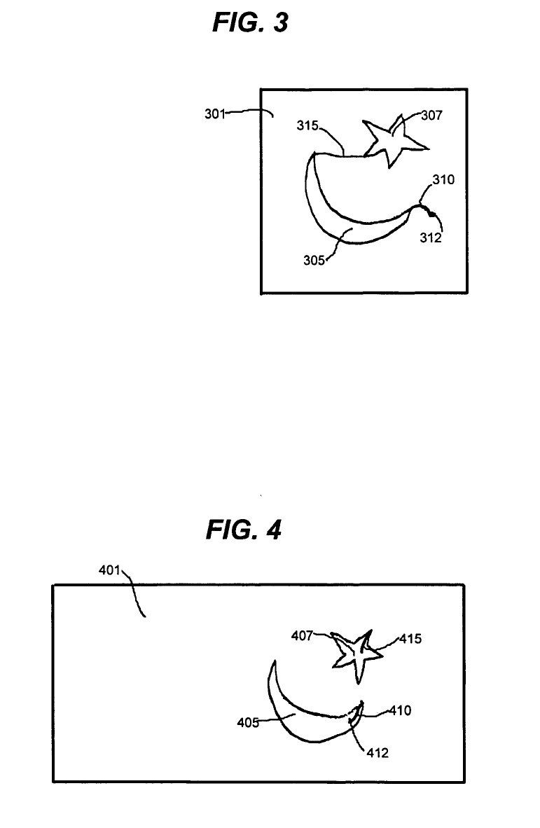

The artistic design at this stage of the process resides in CAD (i.e., AutoCAD Lite v. 12, in this specific illustrative embodiment of the invention), has been cleaned-up by a computer operator (not shown), and now must be transferred to a program that is capable of driving a computer numeric control (“CNC”) system. There are several commercially available software systems, and it is recognized that persons of skill in the can select and configure a suitable product that will satisfy the requirements of the present invention. In a practical embodiment of the invention, the CAD document file is converted to, for example, SmartCam software at step 120 and is saved as a numerical control (“NC”) file. The resulting NC CAD file is then converted to, for example, LaserControllerCAD, a commercially available software product, that inserts start and stop points for the laser head (not specifically designated). As will be discussed in connection with FIGS. 3 and 4, tag lines are inserted at each start point to provide for the laser cutting path a smooth entry into the perimeter of the cuts that will be made, as described below. Further at step 120, background panel 140 is prepared for laser cutting, which may include clamping of the background panel to CNC controlled work table 130. Since in this specific illustrative embodiment of the invention, two CNC controlled work tables 130 and 135 are employed, the laminate (not shown in this figure) is prepared, and in certain embodiments, it is clamped to CNC controlled work table 135. However, in embodiments where only one CNC controlled laser arrangement is used, after the background panel has been cut and the required voided space created, the background panel is then set aside and the same machine is then prepared for cutting the inlay element.

In a practical embodiment, when cutting laminate, it may be useful to tape the pieces after the initial cut, so as to hold them on the initial plane of the inlay element end panel. This will prevent the smaller pieces from falling into the burn trough and smoke exhaust system and becoming irretrievable or burned by the unfocused laser beam as it hits the bottom of burn trough.

When all the inlay elements are cut, they are set aside for assembly in later steps.

At step 132, the coordinates of the SmartCam software are sent to CNC control board 130 for effecting the cut of a background panel 140. In this specific illustrative embodiment of the invention, there is formed a through aperture 142 that corresponds in its configuration to the design on art master 100.

At step 137, the coordinates of the SmartCam software are sent to the CNC control board 135 for effecting the cut of the laminate (not shown in this figure). This results in the cutting out of inlay element 144. As shown, all laminate material external to inlay element 144 has been removed.

In some embodiments of the invention, the operator (not shown), at step 138 may perform several steps to clean-up and prepare the image for use in the laser-cutting steps. This may include, for example: converting curves that previously were auto-formed as tiny linear approximations into mathematically described curves; straightening imperfect lines, if it improves the design; and offsetting the image if the image contains fine detail, whereby an allowance is made for the 0.014″ laser beam width. In most instances, it has been discovered that the offset will not be necessary, since the width of the laser beam can be used to create a small tolerance that will allow the parts of the inlay to be fitted together easily without being too snug. In particular, it has been learned that small parts often will require additional re-adjustment. For instance a 1.0″ hole may need to be made into a 0.986″ hole to accommodate the 0.014″ width of the laser beam. If the laminate for a wood background panel is to be cut, it is not generally necessary to re-adjust the laser path code, since the width of the laser beam creates the desired clearance. Additionally, in embodiments where the inlay is to be made entirely of wood, space should be provided for the materials to move and shift with changes in humidity. In addition to the foregoing, lead-in lines may also be added by the operator so as to avoid the pin point holes that the laser often creates in its initial burst of energy. The laser often will form a hole of approximately 0.05″ upon being powered up. Accordingly, it is advisable to start the laser while it is over an area of the cut-out that ultimately will become scrap. For inlay element 144, the laser cut will begin outside of the image, and for background panel 140, the laser will be started while it is in the voided image. These lead-in lines will be described in detail below in connection with FIGS. 3 and 4.

In order to ensure fidelity to the original design, in a practical operating environment, all design changes are made by, or under the supervision of, the original designer of the artwork. A hard copy of the actual laser cut pathway (not shown) is then created and saved in a three-ring binder after being assigned a product code for use in later production.

In a practical embodiment of the invention, background panel 140 has a thickness of 0.25″, and is commercially available in a 4′×8′ sheet. The background panel has an MDF core with a select white maple veneer face on one side and a B grade (lower quality) veneer face on the reverse side. Such a background panel is manufactured by Georgia Pacific. However, almost any panel of any composition or thickness can be employed in the practice of the invention, and persons of skill in the art can configure the laser and its cutting power accordingly. Background panel 140 may also be formed of solid wood, particle board, MDF, plywood, laminate, solid surface composed of polyester or acrylic (such as Corian or Avonite) or any other material capable of being cut with a laser beam. It should be noted, however, that the glue that is used to laminate the veneer should not be an exterior glue having a phenolic composition. Such known glue will tend to ignite when subjected to a laser beam.

In the practice of the invention, background panel 140 is placed on CNC controlled work table 130. The CNC controlled work table in this specific illustrative embodiment of the invention is capable of x-axis and y-axis movement, and has associated therewith a fixturing system (not shown) that holds background panel 140 in place without movement. Background panel 140, however, is be supported and suspended in a manner that will allow the laser beam to pass through the panel and without impinging upon any material located beneath the panel that might reflect back heat and scorch or smoke-stain the panel. Further in accordance with this embodiment, blower or vacuum units (not shown) are placed in the laser apparatus (not specifically identified) to evacuate the smoke and the debris generated during laser cutting. The blower or vacuum reduces smoke damage to the wood and the degradation of the intensity of the laser beam that results from the scattering of the light due to such smoke and debris.

In one embodiment, the laser is a 400 watt system that uses CO₂ gas. A variety of wattages can be used in the practice of the invention, but care must be taken to adjust the laser power so that the beam will cut through the material, but will not cause undue charring. The inventor herein has determined that CO₂ gas serves well in most situations and with most materials since it diminishes burning of the material. However, other materials, such as metal, may require other gases to aid in the cutting process. It has been discovered that a 400 Watt laser can be used to cut up to a 1″ panel of dieboard Baltic birch plywood. Cutting with dimensional accuracy depends to a significant extent on the consistency of the material and the power of the laser.

In a preferred embodiment, the laser arrangement has a fixed head with approximately 1″ of z-axis movement to allow for slight curvature in the wood. The aforementioned machine coordinates drive CNC controlled work table 130 capable of moving in the x-axis and y-axis directions a 4′×8′ sheet of material (not shown). It is understood that any practitioner of the laser-cutting art can use a CNC cutting arrangement having greater than two axes of motion for the purposes of the invention.

In a preferred embodiment, each of background panels 140 is pre-sanded to 180 grit. Other grits may be employed in the practice of the invention, and additional sanding may be performed at a later stage, as desired.

FIG. 2 is a simplified function block and schematic representation that illustrates an assembly process for creating a finished product having an inlay in accordance with the principles of the invention. As shown in step 200 of this figure, background panel 140 with aperture 142 therethrough is bonded to a substrate 210 to form a composite panel 218. In addition, in this specific illustrative embodiment of the invention, a backer panel 215 is bonded to the reverse side of substrate 210 to provide a quality finish to that side. In embodiments where there is no need for a quality finish on the reverse side of substrate 210, backer panel 215 will not be provided.

In the practice of the invention, background panel 140 may have various voids (not shown) therethrough, particularly in embodiments where plural artistic designs are desired to be installed therein. In a practical embodiment of the invention, composite panels are constructed having a thickness of 1.25″. Thus, background panel 140, as mentioned earlier, consists of a 0.25″ select white maple plywood panel with MDF core. Substrate 210 is made of MDF having a thickness of 0.75″. This substrate provides an advantageous combination of cost and core stability. Backer panel 215 is, in this specific illustrative embodiment of the invention, also a 0.25″ maple veneer MDF.

The glue that is used to effect the bonding may be, for example, Borden's white glue, but any suitable carpentry glue, contact cement, or fixative is acceptable. The glue is applied to both sides of substrate 210 using a spreader, as will be described below. Care should be taken in spreading the glue to prevent excess glue from seeping back into the area where the inlays will be placed. The panel is then placed in a conventional panel press (not shown) and approximately 50 pounds per square inch of pressure is applied to the glued panels. Subsequently, an edge material (not shown), or other structural or decorative elements are bonded to the composite panel.

In this embodiment, the composite panel is edge-banded using a 0.25″ thick Maple edging (not shown). The edge band is butt jointed at the top and bottom joints (not shown), and can, if desired, be miter cut. The edge band is affixed using a standard white carpenters glue and clamped using conventional pipe clamps (not shown) applied with wood blocks (not shown) to prevent denting. After the glue has set for a suitable period, the edging is planed or sanded flush to the composite panel surface. After being shaped, the edge is then sanded to 180 grit to bring it into surface compliance with the rest of the composite panel

At step 220, composite panel 218 is sanded and finished. A light case-clean sanding using 180 grit sand paper and an orbital sander is applied to the entire composite panel to prepare it for finishing. Wood dust (not shown) is blown off the panel, and an aniline dye stain (not shown) or opaque paint (not shown) is applied to the entire surface. It is an advantage of the present invention that no masking is required for the voided areas where the inlays will be applied. This results in significant economy and allows the color finish to be applied in mass-production fashion. In the preferred embodiment, two sealer coats (not shown) of clear-coat lacquer with 30 sheen are then applied. Composite panel 218 is then set aside to await preparation of inlay element 144. Continuing with step 220, any additional inlay elements (not shown) that may be necessary are cut from second or subsequent inlay panels (not shown), are then sanded, prepared for finishing, and then finished. Of course, finishing of inlay element 144 may not be necessary in embodiments where it is formed of HPPL, Corian, metal, etc.

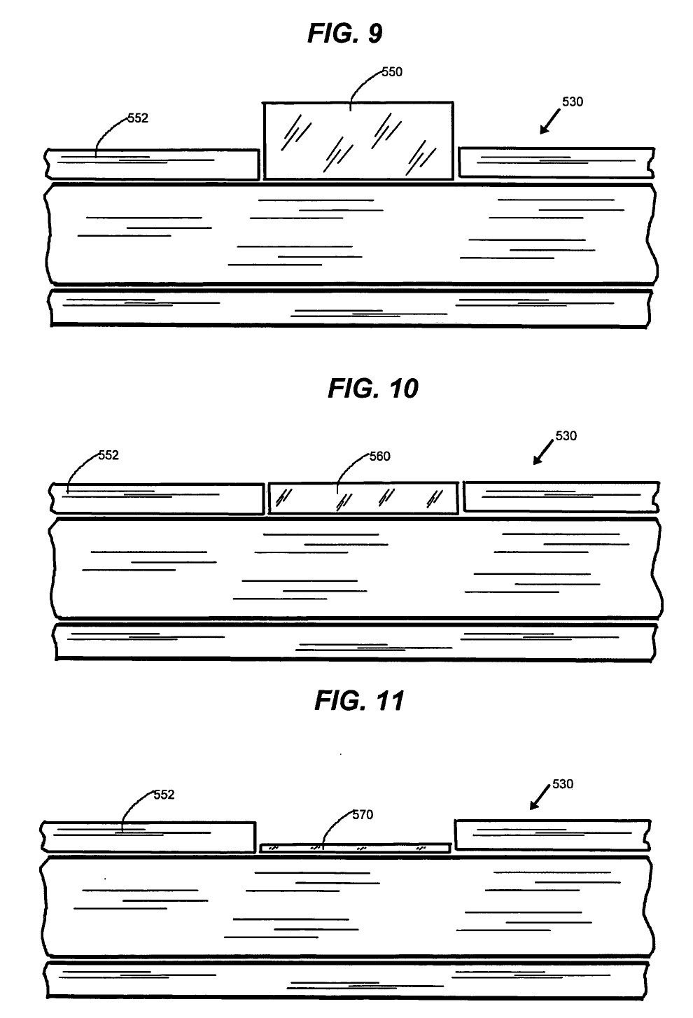

Inlay element 144 is bonded to composite panel 218 at step 230. In one embodiment, an epoxy having a curing time of 3 minutes provides sufficient time to place and hold down the elements for a secure bond. Generally, hand pressure alone has been adequate to secure the inlay elements. However, weights or clamps can be used to hold the elements in place for a longer period of time, or to achieve a more secure curing, or if other bonding materials are used, such as construction adhesive or 3M Jet Weld. Epoxy cleans up easily from the finished surface in the event of spills. As will be described below in connection with FIGS. 9, 10, and 11, the present invention accommodates the inlay to be in raised relief, flush, or in recessed relief. Additionally, the present process may be applied to articles where the surface is curved or arcuate.

At step 240, the finished composite panel with affixed inlay elements is then incorporated into the overall furniture or decorative object. In this specific illustrative embodiment of the invention, the resulting product is a shelf unit 250. The disclosed embodiment described herein is a shelf end panel 251 that is then attached to a metal shelf unit 256. Alternatively, shelf end panel 251 can be combined with a wooden shelf unit or a carrel, or a large head-board panel for a bed. In such an item of furniture, the decorated end panel may be inset in a larger frame on the headboard panel. Thus, the end panel may itself be an inlay element, giving rise to inlays within inlays.

FIG. 3 is a representation of an art master in the form of a free-hand sketch, showing the cutting pathways for the inlay material panel. As shown, an image 301 for the inlay panel shows two major images, a moon image 305 and a star image 307. Moon image 305 is shown to have attached thereto a short lead-in line 310, which in this embodiment is approximately 0.2″ long. The laser (not shown) will commence its cut at point 312 of lead-in line 310, and will cut therealong before it will start cutting the perimeter of moon image 305. However, the use of a lead-in line is not generally necessary in situations where the thickness of the inlay material is about ¼″ or less. Star image 307 is, in this specific illustrative embodiment of the invention, cut after moon image 305 is cut, such cutting being continued after the laser head (not shown) travels along connecting path 315. In some embodiments, the laser does not cut along connecting path 315, or cutting may be discontinued shortly after cutting moon image 305 and resumed shortly before the laser head reaches the beginning of star image 307.

FIG. 4 is a representation of the art master of FIG. 3 showing the cutting pathways for a background panel. Image 401 for the background panel shows, as is the case with FIG. 3, two major images, a moon image 405 and a star image 407. Moon image 405 is shown to have attached thereto a short lead-in line 410, which is disposed inward of the perimeter of the moon image, and in this embodiment is approximately 0.2″ long. The laser (not shown) will commence its cut at point 412 of lead-in line 410, and will cut therealong before it will start cutting the perimeter of moon image 405. However, the use of a lead-in line is not generally necessary in situations where the thickness of the inlay material is about ¼″ or less. Star image 407 is, in this specific illustrative embodiment of the invention, begun to be cut after the laser head (not shown) travels along lead-in line 415.

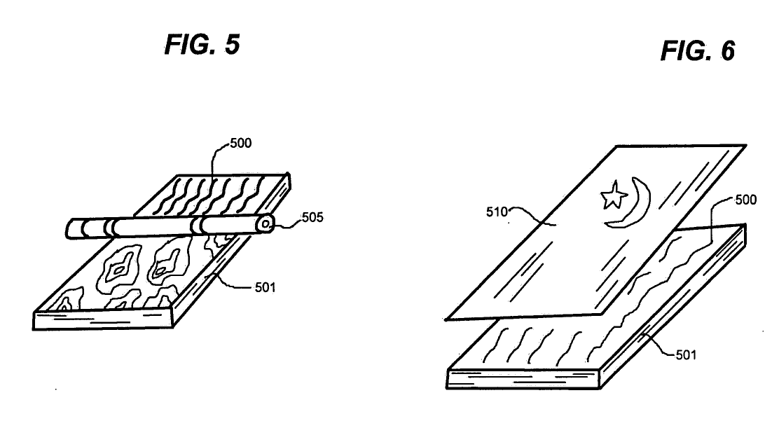

FIG. 5 is a representation of the application of a glue 500 on a substrate panel 501 using a conventional glue applicator roller 505. As previously stated, the amount of glue that is applied should be controlled to prevent excess glue from being squeezed into the voids of the background panel (not shown in this figure).

FIG. 6 is a representation of the installation of a background panel 510 onto substrate panel 501 with glue 500 thereon, as shown in FIG. 5. As previously noted, background panel 510 is then placed in a conventional panel press (not shown) and approximately 50 pounds per square inch of pressure is applied to the glued panels.

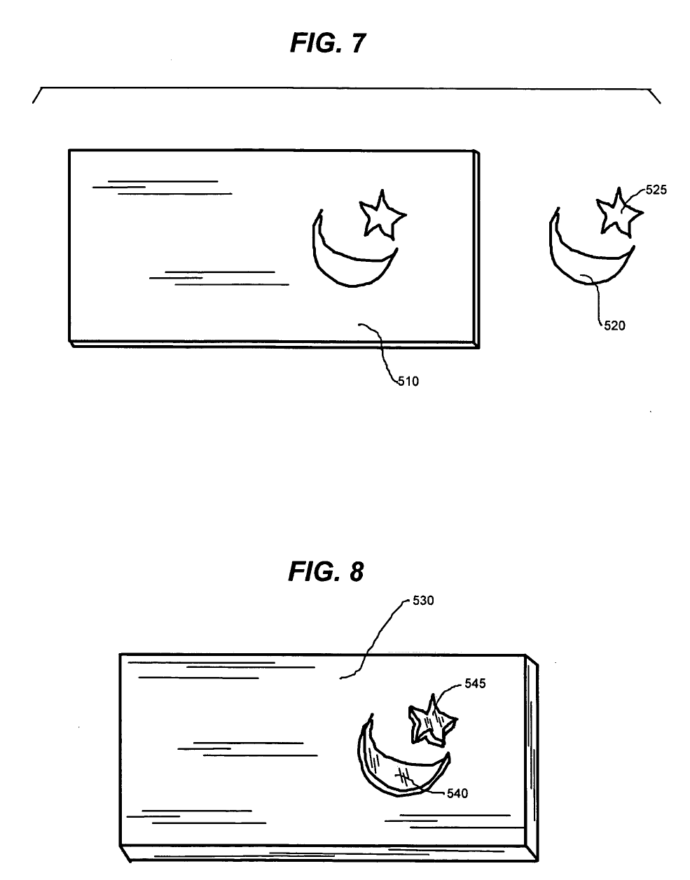

FIG. 7 is a representation of background panel 510 with a laser cut therein separated from inlay elements 520 and 525, which in this specific illustrative embodiment of the invention are formed of a laminate.

FIG. 8 is a representation of a completed panel 530 having raised inlays 540 and 545 installed thereon.

FIG. 9 is a cross-sectional representation of an embodiment of the invention having a raised relief characteristic. As shown, completed panel 530 has an inlay element 550 thereon that is thicker than background panel 552. Therefore, inlay element 550 will appear as a raised decorative element.

FIG. 10 is a cross-sectional representation of an embodiment of the invention having a flush relief characteristic. As shown, completed panel 530 has an inlay element 560 thereon that is of approximately the same thickness as background panel 552. Therefore, inlay element 550 will appear as a flush decorative element.

FIG. 11 is a cross-sectional representation of an embodiment of the invention having a recessed relief characteristic. As shown, completed panel 530 has an inlay element 570 thereon that is thinner than background panel 552. Therefore, inlay element 550 will appear as a recessed decorative element.

Although the invention has been described in terms of specific embodiments and applications, persons skilled in the art can, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof

What is claimed is:

1. A method of making an inlaid panel using a laser cutter, the method comprising the steps of:
a. providing an art master rendering that is desired to constitute a decorative design for the inlaid panel;
b. scanning electronically the art master to form an art master data file;
c. transferring the art master data file to a CAD software system to form an art master CAD file having machine code coordinates;
d. coordinating a laser beam to cut-through a first background panel and create negative image voids on the inlaid panel;
e. driving a CNC laser cutting machine in response to the machine code coordinates;
f. second coordinating a laser beam to cut through a second panel for forming positive images that become inlay elements;
g. bonding the first background panel and the second panel for forming a composite panel;
h. placing the inlay element in appropriate voided spaces on the background panel and bonded to the substrate;
i. finishing the composite panel; and
j. finishing the inlay elements.

2. The method of claim 1, wherein there is provided the further step of incorporating the finished composite panel with affixed inlay elements into an overall furniture or decorative object.

3. The method of claim 1, wherein, prior to performing said step of second coordinating there is further provided the step of re-adjusting the machine code coordinates.

4. The method of claim 1, wherein, prior to performing said step of placing the inlay element there is further provided the step of bonding a backer panel to the composite panel.

5. The method of claim 1, wherein, prior to performing said step of placing the inlay element there is further provided the step of bonding an edger material to the composite panel.

6. The method of claim 1, wherein, prior to performing said step of placing the inlay element there is further provided the step of affixing a structural support to the composite panel.

7. The method of claim 1, wherein, prior to performing said step of placing the inlay element there is further provided the step of affixing a further decorative element to the composite panel.

8. A method of producing an inlay of one material in another material, the method comprising the steps of:
a. electronically scanning an art master;
b. first laser cutting a panel to create a voided image in the panel;
c. second laser cutting to create an inlay image; and
d. bonding the panel and the inlay image to a substrate to form an inlayed panel.

9. The method of claim 8, wherein prior to performing said step of electronically scanning there is provided the further step of forming the art master as a graphic design.

10. The method of claim 9, wherein during said step of electronically scanning there is provided the further step of converting the graphic design into machine code.

11. The method of claim 10, wherein said machine code has a CAD format.

12. The method of claim 11, wherein there is further provided the step of enabling the machine code in CAD format to drive a laser-cutting machine.

13. The method of claim 12, wherein said step of enabling comprises the further step of cleaning the machine code in CAD format so that it can drive a laser-cutting machine.

14. The method of claim 11, wherein the machine code in CAD format controls a laser beam to cut a negative, voided image in a background panel.

15. The method of claim 14, wherein the machine code in CAD format is cleaned-up and offsets are allowed to make the negative, voided image in the background panel.

16. The method of claim 14, wherein the negative, background panel is bonded to a substrate panel

17. The method of claim 11, wherein the machine code in CAD format controls a laser beam to cut a positive image in an relay panel.

18. The method of claim 17, wherein the machine code in CAD format is cleaned-up and offsets are allowed to make the positive image in the relay panel.

19. The method of claim 8, wherein there is provided the further step of filling the voided image in the panel with a positive inlay image

20. The method of claim 19, wherein there is further provided the step of bonding the positive inlay image to a substrate.

21. The method of claim 8, wherein the background panel is made of wood, and there is provided the further step of staining the background panel without affecting the inlay element.

22. The method of claim 8, wherein the background panel is made of wood, and there is provided the further step of sealing the background panel without affecting the inlay element.
